(19) United States
(12) Patent Application Publication
(10) Pub. No.: US 2019/0206359 A1
(43) Pub. Date: Jul. 4, 2019

(54) FLOATING DISPLAY DEVICE

(71) Applicant: BOE Technology Group Co., Ltd., Beijing (CN)

(72) Inventor: Kai Lin, Beijing (CN)

(21) Appl. No.: 16/145,852

(22) Filed: Sep. 28, 2018

(30) Foreign Application Priority Data
Jan. 2, 2018 (CN) 201810001286.3

(51) Int. Cl. G09G 5/00; H02J 50/10; H02J 7/02

(52) U.S. Cl. CPC G09G 5/006; H02J 50/10; G09G 2300/026; G09G 2370/16; H02J 7/025

(57) ABSTRACT

This disclosure provides a floating display device. The floating display device comprises a base and a floating display suspended above the base. The floating display comprises a first magnet and a receiver coil. The base comprises a second magnet and a transmitter coil. The first magnet and the second magnet have repulsive magnetism, and when the transmitter coil is energized, a magnetic field is generated, the floating display suspended above the base is charged through the receiver coil.

### CROSS REFERENCE TO RELATED APPLICATION

The present application claims the priority of the Chinese patent application for invention No. 201810001286.3 filed on Jan. 2, 2018, the entire content of which is incorporated herein by reference.

### TECHNICAL FIELD

This disclosure relates to the field of display technology, particularly to a floating display device.

### BACKGROUND

The display devices (such as televisions, electronic picture frames etc.) at present are generally fixed on the wall or placed on the table. Moreover, the display device connects the external power supply through a power line and receives a data signal through a data line. This may need to punch holes on the wall and mount a fixed bracket, thus resulting in damage to the wall. Moreover, various connecting lines can be seen, thereby influencing the appearance.

### SUMMARY

An aspect of this disclosure provides a floating display device.

In one embodiment, the floating display device comprises a base and a floating display suspended above the base. The floating display comprises a first magnet and a receiver coil. The base comprises a second magnet and a transmitter coil. The first magnet and the second magnet have repulsive magnetism, and when the transmitter coil is energized, a magnetic field is generated, the floating display suspended above the base is charged through the receiver coil.

In one embodiment, the floating display comprises a plurality of display screens. The plurality of display screens are arranged on outside surfaces of the floating display, and face different directions respectively.

In one embodiment, the first magnet is fixed at center of the floating display.

In one embodiment, the receiver coil is arranged at a bottom of the floating display.

In one embodiment, the floating display further comprises a rectifier circuit and a voltage stabilizing circuit connected with the receiver coil.

In one embodiment, the transmitter coil comprises a plurality of transmitter sub-coils. A density of transmitter sub-coils arranged in a middle area of the base is larger than a density of transmitter sub-coils arranged in a marginal area of the base.

In one embodiment, a size of the base is larger than a size of the floating display, and the base has a depressed top surface.

In one embodiment, the floating display further comprises a wireless receiving device for receiving a data signal.

In one embodiment, the base further comprises a storage device for storing data to be displayed, and a wireless transmitting device for transmitting the data to be displayed.

In one embodiment, the base further comprises an energy storage device for storing electric energy from a power supply.

### BRIEF DESCRIPTION OF THE DRAWINGS

The drawings are used for providing further understanding to this disclosure, and constitute a portion of the description, for explaining this disclosure together with the embodiments below, however, they do not constitute limitations to this disclosure. In the drawings:

FIG. 1A and FIG. 1B schematically show floating displays according to embodiments;

FIG. 2 schematically shows an internal structure of a floating display according to an embodiment;

FIG. 3 schematically shows an internal structure of a base according to an embodiment;

FIG. 4 schematically shows arrangement of transmitter coils in the base according to an embodiment; and

FIG. 5 schematically shows a floating display device according to an embodiment.

### DETAILED DESCRIPTION

In order to enable the purposes, the technical solutions and the advantages of this disclosure to be clearer, next, this disclosure will be described in more detail in conjunction with the drawings. Apparently, the embodiments described are only a part of rather than all of the embodiments of this disclosure. Based on the embodiments in this disclosure, all other embodiments obtained on the premise that the ordinary skilled person in the art does not pay any inventive effort, belong to the protection scope of this disclosure.

The shapes and the sizes of the components in the drawings do not reflect the real proportion, which only aims to explain the content of this disclosure.

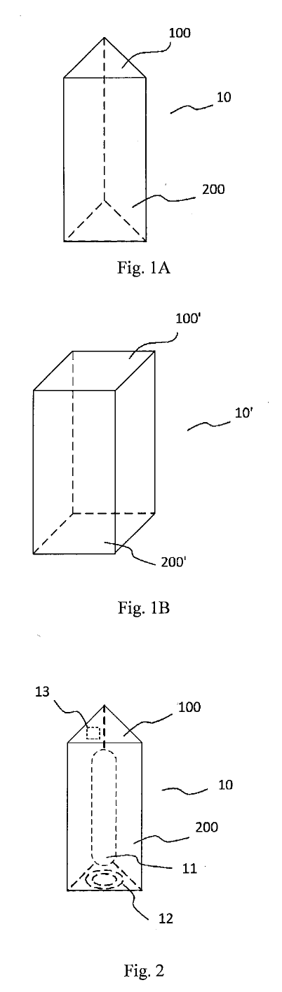

FIG. 1A and FIG. 1B schematically show floating displays according to embodiments.

As shown in FIG. 1A, a floating display 10 comprises a display body 100 and three display screens 200. The three display screens 200 are located on different sides of the display body 100 respectively, so as to face different directions respectively. The display body 100 has a triangular prism structure. As shown in FIG. 1B, the floating display 10′ comprises a display body 100′ and four display screens 200. The four display screens 200 are located on different sides of the display body 100′ respectively, so as to face different directions respectively. The display body 100 has a quadrangular prism structure.

The display screens 200 facing different directions can display video or information to users at different positions, for the convenience of users at different positions to view. Alternatively, the display screens 200 can display different videos or information respectively so as to meet different requirements of different users.

The embodiments as shown in FIG. 1A and FIG. 1B are only used as examples, the number of the display screens comprised by the floating display in the floating display device according to embodiments of this disclosure can be set based on user requirements, which is not limited specifically. For example, the floating display can only comprise one display screen, or the floating display can comprise a plurality of display screens. According to an embodiment of this disclosure, the display body can have a cylindrical structure, and one display screen 200 can be a flexible display screen so as to be formed on the outer circumferential surface of the display body with the cylindrical structure. In addition, in the event that the display body has a cylindrical structure, the number of the flexible display screen 200 is not limited to one, instead, it can comprise a plurality of flexible display screens 200, so as to be formed on different portions of the outer circumferential surface of the display body respectively.

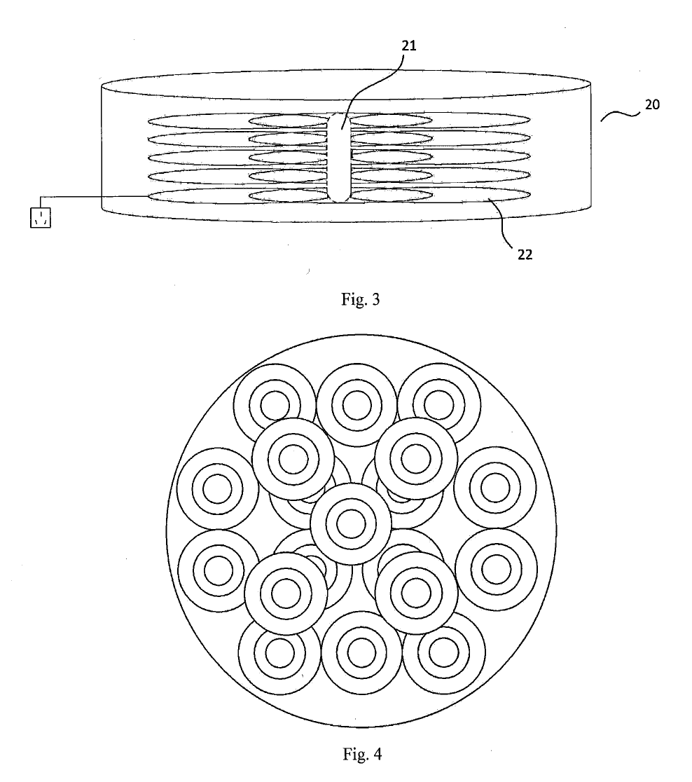

FIG. 2 schematically shows an internal structure of the floating display 10 according to an embodiment.

As shown in FIG. 2, the floating display 10 comprises a display body 100 and three display screens 200, and the display body 100 has a triangular prism structure. According to an embodiment of this disclosure, the floating display 10 can comprise a first magnet 11, and the first magnet 11 is preferably located in a central area of the floating display. The floating display 10 can further comprise a receiver coil 12, and the receiver coil 12 is preferably arranged at the bottom of the floating display. Although not shown in the figure, the floating display 10 can further comprise a rectifier circuit and a voltage stabilizing circuit connected with the receiver coil 12, for rectifying and regulating the voltage of the receiver coil 12, so as to supply power to the display screens. In addition, according to an embodiment of this disclosure, the floating display 10 can further comprise a wireless receiving device 13 for receiving a data signal. The floating display 10 drives the display screens 200 based on the received data signal.

The wireless receiving device 13 can receive the data signal according to various wireless communication modes, including (but not limited to): Wireless-Fidelity (Wi-Fi), Light Fidelity (LIFI), BlueTooth, ZigBee. The wireless receiving device 13 can comprise an interface corresponding to the wireless communication mode. The wireless receiving device 13 can receive a data signal from an external device other than the floating display device according to an embodiment of this disclosure. Alternatively, the wireless receiving device 13 can receive a data signal from the base 20 (see FIG. 3).

It should be recognized that FIG. 2 illustrates the components of a floating display 10 by taking the floating display 10 with a triangular prism structure as shown in FIG. 1A as an example, however, it is only used as an example rather than limitation. For example, the floating display can have the quadrangular prism structure as shown in FIG. 1B so as to comprise four display screens, or alternatively, can have a cylindrical shape so as to only comprise one display screen.

FIG. 3 schematically shows an internal structure of a base 20 according to an embodiment.

As shown in FIG. 3, the base 20 comprises a second magnet 21, and the second magnet 21 is preferably located in a central area of the base 20. The base 20 can further comprise a transmitter coil 22, and the transmitter coil 22 preferably comprises a plurality of transmitter sub-coils. According to an embodiment of this disclosure, the base 20 can further comprise a power line and an energy storage device. The power line is used for connecting a power supply so as to supply power for the base 20. The energy storage device is used for storing electric energy from the power supply. Additionally or alternatively, the base 20 can further comprise a battery, which supplies power for the base 20.

Although not shown in the figure, the base 20 can further comprise a storage device and a wireless transmitting device. The storage device is used for storing data that needs to be displayed by the floating display 10 (see FIG. 2), and the wireless transmitting device is used for transmitting the data that needs to be displayed by the floating display 10. The wireless receiving device 13 (see FIG. 2) in the floating display 10 receives a data signal transmitted by the wireless transmitting device of the base 20, so as to display the data stored in the storage device in the base 20.

According to an embodiment of this disclosure, the base 20 can comprise a card slot (not shown) to interface with various memory cards respectively, and the wireless transmitting device of the base 20 can transmit the data stored in the memory card inserted into the card slot. The floating display 10 receives the data transmitted by the base 20 via the wireless receiving device 13.

According to an embodiment of this disclosure, the base 20 can further comprise a data receiving device (not shown) for receiving data from an external device other than the floating display device according to an embodiment of this disclosure. In such a case, the storage device of the base 20 can store data received via the data receiving device. The data receiving device of the base 20 can receive data from the external device in a wired and/or wireless manner.

FIG. 4 schematically shows arrangement of transmitter coils in the base 20 according to an embodiment.

As shown in FIG. 4, a plurality of transmitter sub-coils are arranged in the base 20, and the density of the transmitter sub-coils arranged in the middle area of the base 20 is larger than the density of transmitter sub-coils arranged in a marginal area of the base 20. Since the transmitter sub-coils close to the middle area of the base 20 have a large amount and a large density, it is advantageous to perform inductive charging to the floating display 10 suspended above the middle area of the base, thereby improving the charging efficiency.

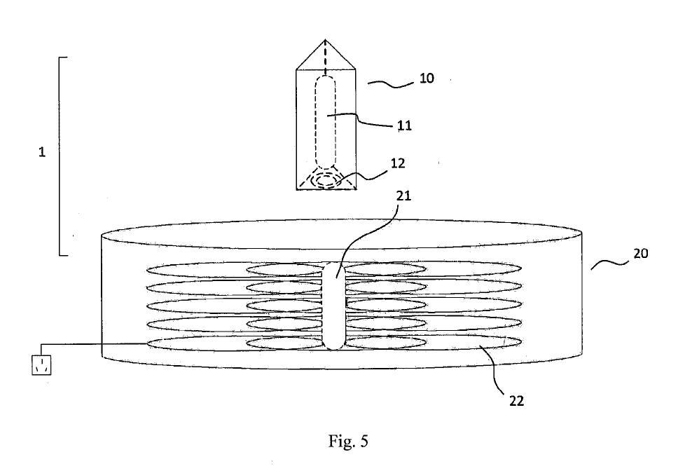

FIG. 5 schematically shows a floating display device according to an embodiment.

FIG. 5 describes a floating display device 1 according to an embodiment of this disclosure by taking the floating display 10 as shown in FIG. 2 and the base 20 as shown in FIG. 3 as the example. The floating display device as shown in FIG. 5 is only used as an example, rather than limitation.

As shown in FIG. 5, the first magnet 11 located in the central area of the floating display 10 and the second magnet 21 located in the central area of the base 20 are facing to each other, and the polarities of the first magnet 11 and the second magnet 21 facing to each other are same. For example, the magnetism of the first magnet 11 facing to the second magnet 21 is N pole, and the magnetism of the second magnet 21 facing to the first magnet 11 is also N pole. Alternatively, the magnetism of the first magnet 11 facing to the second magnet 21 is S pole, and the magnetism of the second magnet 21 facing to the first magnet 11 is also S pole. Due to the principle that like-poles are repulsive, the floating display 10 is enabled to suspend above the center of the base 20.

In order to enable the floating display 10 to suspend perpendicular to the base 20, preferably, the first magnet 11 is fixed on a central axis line of the floating display 10 perpendicular to the ground, and the second magnet 21 is fixed on a central axis line of the base 20 perpendicular to the ground. The size of the base 20 can be larger than the size of the floating display 10. According to an embodiment of this disclosure, the base 20 has a depressed top surface (not shown in the figure). Such a structure enables the floating display to be completely detached from the base.

The floating display device according to an embodiment of this disclosure provides a mounting and power supply mode different from the conventional display device. Because the floating display suspends above the base, it is not required to punch holes on the wall and mount a fixed bracket to fix the floating display, in this way, the wall will not be damaged, and moreover, it simplifies the workload required by mounting the display. Since the floating display does not need to be mounted on the wall, it can have more than one display screen. The floating display with a plurality of display screens can display video or information to users at different positions, which is convenient for the users at different positions to view. The display screens can also display different videos or information, thus being capable of meeting different requirements of different users.

Because the floating display device according to an embodiment of this disclosure performs inductive charging through the transmitter coil located in the base and the receiver coil located in the floating display, and performs wireless data transmission through the wireless transmitting device located in the base and the wireless receiving device located in the floating display, no power line or data line is required between the floating display and the base.

Apparently, the skilled person in the art can make various amendments and modifications to this disclosure without departing from the spirit and the scope of this disclosure. In this way, provided that these amendments, and modifications of this disclosure belong to the scopes of the claims of this disclosure as well as the equivalent technologies thereof, this disclosure also intends to encompass these amendments and modifications.

1. A floating display device, comprising:
a base; and
a floating display suspended above the base,
wherein the floating display comprises a first magnet and a receiver coil,
wherein the base comprises a second magnet and a transmitter coil,
wherein the first magnet and the second magnet have repulsive magnetism, and
wherein when the transmitter coil is energized, a magnetic field is generated and the floating display suspended above the base is charged through the receiver coil.

2. The floating display device of claim 1,
wherein, the floating display comprises a plurality of display screens, and
wherein the plurality of display screens are on outside surfaces of the floating display and facing different directions respectively.

3. The floating display device of claim 1, wherein the first magnet is fixed at a center of the floating display.

4. The floating display device of claim 1, wherein the receiver coil is at a bottom of the floating display.

5. The floating display device of claim 1, wherein the floating display further comprises a rectifier circuit and a voltage stabilizing circuit connected to the receiver coil.

6. The floating display device of claim 1,
wherein the transmitter coil comprises a plurality of transmitter sub-coils, and
wherein a first density of first transmitter sub-coils of the plurality of transmitter sub-coils in a middle area of the base is larger than a second density of second transmitter sub-coils of the plurality of transmitter sub-coils in a marginal area of the base.

7. The floating display device of claim 1,
wherein a first size of the base is larger than a second size of the floating display, and
wherein the base comprises a depressed top surface.

8. The floating display device of claim 1, wherein the floating display further comprises a wireless receiving device configured to receive a data signal.

9. The floating display device of claim 8, wherein the base further comprises:
a storage device configured to store data to be displayed; and
a wireless transmitting device configured to transmit the data to be displayed.

10. The floating display device of claim 1, wherein the base further comprises an energy storage device configured to store electric energy from a power supply.
